(19) United States
(12) Patent Application Publication
(10) Pub. No.: US 2023/0095350 A1
(43) Pub. Date: Mar. 30, 2023

(54) FOCUS GROUP APPARATUS AND SYSTEM

(71) Applicant: Smart Science Technology, LLC, Austin, TX (US)

(72) Inventor: Duane Varan, Austin, TX (US)

(21) Appl. No.: 17/447,946

(22) Filed: Sep. 17, 2021

(51) Int. Cl. H04N 21/422; H04N 21/442; H04N 21/258; G06F 3/01

(52) U.S. Cl. CPC H04N 21/42201; G06F 3/011; H04N 21/25891; H04N 21/42204; H04N 21/44218

(57) ABSTRACT

A focus group system for determining the user’s mood or reaction as the user views content based at least in part on physiological indicators measured by a physiological monitoring system and feedback from the user. The system may receive sensor data including physiological data of a user captured while the user is consuming content and receive feedback of the user associated with a reaction of the user when the sensor data was captured. The system may then determine, based at least in part on the sensor data and the feedback, a direction and magnitude of the reaction of the user to the content.

### BACKGROUND

Today, many industries, companies, and individuals rely upon physical focus group facilities including a test room and adjacent observation room to perform product and/or market testing. These facilities typically separate the two rooms by a wall having a one-way mirror to allow individuals within the observation room to watch proceedings within the test room. Unfortunately, the one-way mirror requires the individuals to remain quiet and in poorly lit conditions. Additionally, the individual observing the proceedings is required to either be physically present at the facility or rely on a written report or summary of the proceeding when making final product related decisions.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example focus group platform configured to determine a particular portion of content that is a user’s focus and the user’s mood or reception in association with the focused content according to some implementations.

FIG. 2 illustrates an example side view of the biometric system of FIG. 1 according to some implementations.

FIG. 3A illustrates an example front view of the biometric system of FIG. 1 according to some implementations.

FIG. 3B illustrates an example front view of the eye tracking system of FIG. 1 according to some implementations.

FIG. 4 illustrates an example flow diagram showing an illustrative process for determining a focus of a user and the user’s reaction to the focus according to some implementations

FIG. 5 illustrates an example focus group system according to some implementations.

FIG. 6 illustrates an example eye tracking system associated with a focus group platform according to some implementations.

FIG. 7 illustrates an example user system associated with a focus group platform according to some implementations.

FIG. 8 illustrates an example user system which may be configured to present content to a user and to receive user feedback according to some implementations.

FIG. 9 illustrates an example user system which may be configured to present content to a user and to receive user feedback according to some implementations.

FIG. 10 illustrates an example user system which may be configured to present content to a user and to receive user feedback according to some implementations.

FIG. 11 illustrates an example user system which may be configured to present content to a user and to receive user feedback according to some implementations.

FIG. 12 illustrates an example user system which may be configured to present content to a user and to receive user feedback according to some implementations.

FIG. 13 illustrates an example user system which may be configured to present content to a user and to receive user feedback according to some implementations.

### DETAILED DESCRIPTION

Described herein are devices and techniques for a virtual focus group facility via a cloud-based platform. The focus group platform, discussed herein, replicates and enhances the one-way mirror experience of being physically present within a research environment by removing the geographic limitations of the traditional focus group facilities and augmenting data collection and consumption by users via a physiological monitoring system for the end client and real-time analytics. For example, the system may be configured to determine the user’s mood as the user views content based at least in part on physiological indicators measured by the physiological monitoring system.. In this manner, the user’s response to the content displayed on the particular portion of the display may be determined.

In an example, physiological data of the user may be captured by the physiological monitoring system. Physiological data may include blood pressure, heart rate, pulse oximetry, respiratory rate, brain activity, eye movement, facial features, body movement, and so on. The physiological data may be used in determining a mood or response of the user to content displayed to the user. In some examples, an eye tracking device of the physiological monitoring system as described herein may utilizes image data associated with the eyes of the user as well as facial features (such as features controlled by the user’s corrugator and/or zygomaticus muscles) to determine a portion of a display that is currently the focus of the user’s attention.

In addition, the focus group platform may receive user feedback, for example, via a user interface device. In a particular example, the user may provide user feedback via a user interface device such as a remote control. Utilizing the user feedback and physiological data, the focus group platform may determine the user’s mood or reception in association with the content displayed to the user.

In some examples, the system may be configured to determine a particular word, set of words, image, icon, and the like that is the focus of the user (e.g., using an eye-tracking device of the physiological monitoring system). In such examples, the focus group platform may determine the user’s mood or reception in association with the particular content displayed on the portion of the display.

The user feedback may represent the user’s subjective assessment of the user’s own reaction at a point in time. For example, the user feedback may include a rating of the user’s reaction at a point in time indicating a direction of the user’s reaction and the user’s assessment of the magnitude of that reaction. The user feedback may also be entered without the user indicating the user’s current focus and without the user being directed to focus on any particular portion of the content output to the user (e.g., displayed on a display). The user’s subjective assessment of the user’s own reaction at a point in time may be a reliable indicator of the direction of the user’s reaction (e.g., positive or negative). The user’s assessment of the magnitude of that reaction may be less reliable due to various reasons. For example, some users may find it difficult to provide consistent assessments of the magnitudes of their reactions (e.g., due to the user changing the user’s internal scale when presented with content that evokes greater or lesser reactions than prior content; due to the user feeling uncomfortable admitting the magnitude of the reaction; etc.)

As mentioned above, the physiological data of the user may be utilized to determine the user’s mood or reception in association with the displayed content and/or to determine the focus of the user. In some examples, the determination of the focus of the user based on the physiological data of the user may be reliable. Similarly, the user’s mood or reception in association with the displayed content determined based on the physiological data of the user may be a reliable indicator of the magnitude of the user’s reaction. The determination of the direction of the user’s reaction based on the physiological data of the user may be less reliable. For example, a user’s positive and negative reactions in different contexts and/or for magnitudes of reactions may have similarities in the physiological data of the user. More particularly, a particular change in heart rate, change in blood pressure, change in respiration rate, and/or facial feature or expression may be equally or similarly indicative of a very negative reaction and a mildly positive reaction; a mildly negative reaction and a mildly positive reaction; a mildly negative reaction and a very positive reaction; and so on.

In some examples, by utilizing both the user feedback and the user’s mood or reception in association with the displayed content as determined based on the physiological data of the user, the focus group platform may provide a determination of the user’s mood or reception in association with the displayed content that is a reliable indicator for both direction and magnitude.

The methods, apparatuses and systems described herein can be implemented in a number of ways. Example implementations are provided below with reference to the following figures.

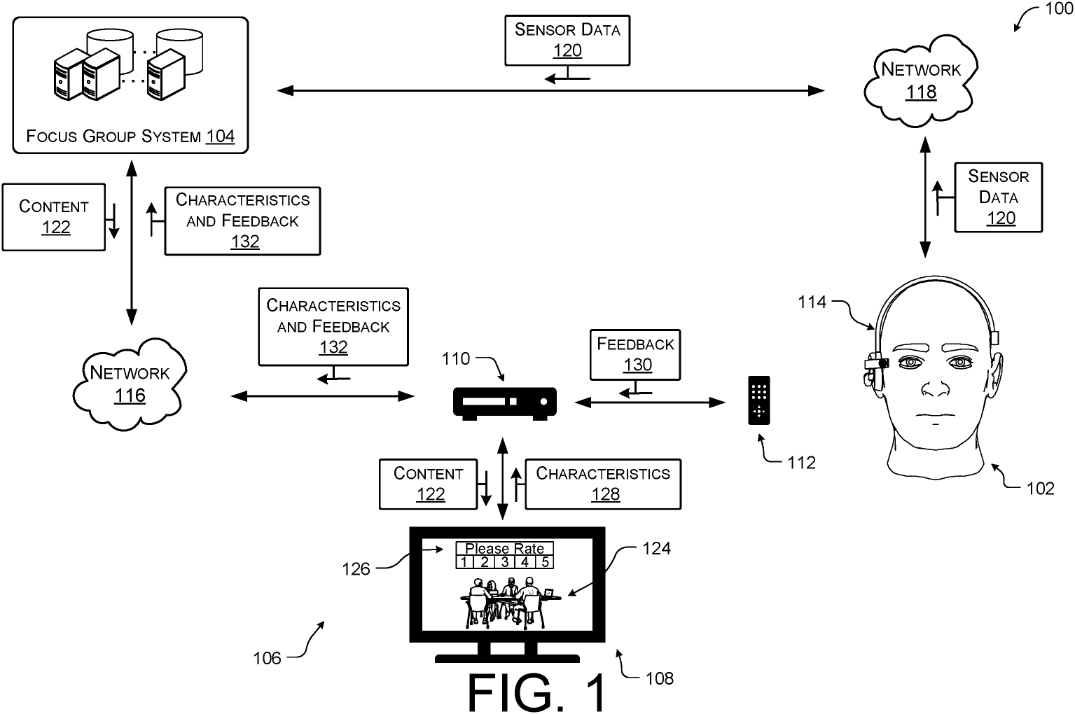

FIG. 1 illustrates an example focus group platform 100 that may determine a focus of a user 102 and the user’s reaction to the focus, according to some implementations. As illustrated, the focus group platform 100 may include a focus group system 104, a user system 106, a remote control device 112, a physiological monitoring system 114, and networks 116 and 118. The user system 106 may include a display device 108 and a set top box 110.

In operation, the physiological monitoring system 114 may be configured to capture sensor data 120. In some examples, the physiological monitoring system 114 may include a headset device that may include one or more inward-facing image capture devices, one or more outward-facing image capture devices, one or more microphones, and/or one or more other sensors (e.g., an eye tracking device). The sensor data 120 may include image data captured by inward-facing image capture devices as well as image data captured by outward-facing image capture devices. The sensor data 120 may also include sensor data captured by other sensors of the physiological monitoring system 114, such as audio data (e.g., speech of the user that may be provided to the focus group platform) and other physiological data such as blood pressure, heart rate, pulse oximetry, respiratory rate, brain activity, body movement, and so on. In the current example, the sensor data 120 may be sent to a focus group system 104 via one or more networks 118.

In one example, an eye tracking device of the physiological monitoring system 114 may be configured as a wearable appliance (e.g., headset device) that secures one or more inward-facing image capture devices (such as a camera). The inward-facing image capture devices may be secured in a manner that the image capture devices have a clear view of both the eyes as well as the cheek or mouth regions (zygomaticus muscles) and forehead region (corrugator muscles) of the user. For instance, the eye tracking device of the physiological monitoring system 114 may secure to the head of the user via one or more earpieces or earcups in proximity to the ears of the user. The earpieces may be physically coupled via an adjustable strap configured to fit over the top of the head of the user and/or along the back of the user’s head. Implementations are not limited to systems including eye tracking and eye tracking devices of implementations are not limited to headset devices. For example, some implementations may not include eye tracking or facial feature capture devices, while other implementations may include eye tracking and/or facial feature capture device(s) in other configurations (e.g., eye tracking and/or facial feature capture from sensor data captured by devices in the display device 108, the set top box 110 and/or the remote control device 112).

In some implementations, the inward-facing image capture device may be positioned on a boom arm extending outward from the earpiece. In a binocular example, two boom arms may be used (one on either side of the user’s head). In this example, either or both of the boom arms may also be equipped with one or more microphones to capture words spoken by the user. In one particular example, the one or more microphones may be positioned on a third boom arm extending toward the mouth of the user. Further, the earpieces of the eye-tracking device of the physiological monitoring system 114 may be equipped with one or more speakers to output and direct sound into the ear canal of the user. In other examples, the earpieces may be configured to leave the ear canal of the user unobstructed. In various implementations, the eye tracking device of the physiological monitoring system 114 may also be equipped with outward-facing image capture device(s). For example, to assist with eye tracking, the eye tracking device of the physiological monitoring system 114 may be configured to determine a portion or portions of a display that the user is viewing (or actual object, such as when the physiological monitoring system 114 is used in conjunction with a focus group environment). In this manner, the outward-facing image capture devices may be aligned with the eyes of the user and the inward-facing image capture device may be positioned to capture image data of the eyes (e.g., pupil positions, iris dilations, corneal reflections, etc.), cheeks (e.g., zygomaticus muscles), and forehead (e.g., corrugator muscles) on respective sides of the user’s face. In various implementations, the inward and/or outward image capture devices may have various sizes and figures of merit, for instance, the image capture devices may include one or more wide screen cameras, red-green-blue cameras, mono-color cameras, three-dimensional cameras, high definition cameras, video cameras, monocular cameras, among other types of cameras.

It should be understood, that as the physiological monitoring system 114 discussed herein may not include specialized glasses or other over the eye coverings, the physiological monitoring system 114 is able to image facial expressions and facial muscle movements (e.g., movements of the zygomaticus muscles and/or corrugator muscles) in an unobstructed manner. Additionally, the physiological monitoring system 114 discussed herein may be used comfortably by individuals that wear glasses on a day to day basis, thereby improving user comfort and allowing more individuals to enjoy a positive experience when using personal eye tracking systems.

Other details of the eye tracking device of the physiological monitoring system 114 and variations thereof are described, for example, in U.S. Pat. Application No. 16/949,722 filed on Nov. 12, 2020 entitled “Wearable Eye Tracking Headset Apparatus and System”, the entire contents of which are hereby incorporated by reference. For example, while examples herein are discussed as having the focus group system perform analysis of sensor data collected by the physiological monitoring system 114, the physiological monitoring system 114 may perform at least part of the analysis of the sensor data and provide the result of the analysis to the focus group system 104.

The focus group system 104 may be configured to interface with and coordinate and/or control the operation of the user system 106 and physiological monitoring system 114. In the discussion below, the focus group system 104 may operate to determine the content output by the user system that is the user’s focus and the user’s response to the content that is the user’s focus. However, this is done for ease of explanation and to avoid repetition. Implementations are not so limited and may the focus group system 104 may operate to determine the user’s response to the displayed content, determine the content output by the user system that is the user’s focus, or a combination thereof. As such, while the following examples are discussed in the context of determining the user’s response to the content that is the user’s focus, implementations include similar examples without focus determination that may operate to determine the user’s response to the displayed content. Similarly, while the following discussion includes physiological monitoring systems that include an eye tracking device that captures physiological data, implementations are not so limited and include implementations without an eye tracking device and which may or may not track eye movement. Such implementations may use physiological data captured by other physiological monitoring devices such as blood pressure monitors, heart rate monitors, pulse oximetry monitors, respiratory monitors, brain activity monitors, body movement capture, image capture devices and so on.

In operation, the focus group system 104 may provide content 122 (e.g., visual and/or audio content) to the user system 106. In the current example, the content 122 may be sent to the user system 106 via one or more networks 116. The set top box 110 of the user system 106 may receive the content 122 and provide the content 122 to the display device 108. The display device 108 may output the content 122 for consumption by the user 102. As illustrated, the content 122 may include visual content 124 (e.g., image or video) as well as other content such as audio content for which the user’s reaction is to be determined. In addition, the content 122 may include a prompt 126 (or other indicator) requesting the user provide a rating or other form of feedback. In some cases, the display device 108 may also provide characteristics 128 associated with the display, such as screen size, resolution, make, model, type, and the like, to the set top box 110.

In response to the prompt 126 included in the content 122, the user 102 may utilize the remote control 112 to input feedback 130 responsive to the content 122. The remote control 112 may output the feedback 130 to the set top box 110 in response to the user input. In the illustrated example, the user may provide a rating on a scale of 1 to 5, with 1 being a strong negative reaction, a 2 being a mild negative reaction, a 3 being a neutral reaction, a 4 being a mild positive reaction and 5 being a strong positive reaction. Of course, this is merely an example and many variations are possible. For example, instead of a typical remote control, the remote control 112 may include a dial with values from -50 to 50, -100 to 100, or 1 to 100 and the prompt 126 may not include a scale, but ask the user to select a value using the dial. Further, implementations are not limited to feedback provided via a set top box or a portion of the user system 106. For example, the physiological monitoring system 114 may further include a user input device through which the user may input the feedback 130. In another example, the display device 108 may have the functions of the set top box 110 integrated, and may perform the functions of both devices.

In response to receiving the feedback 130, the set top box 110 may provide the feedback 130 to the focus group system 104 with the sensor data 120. In the illustrated example, the set top box 110 may output the characteristics 128 and feedback 130 to the focus group system 104 via the network 116 as characteristics and feedback 132. While the characteristics and feedback 132 are illustrated as a combined message, implementations are not so limited as the characteristics 128 and feedback 130 may be provided to the focus group system 104 by the set top box 110 separately and the characteristics 128 may or may not be output with each iteration of feedback 130.

The focus group system 104 may then determine a portion of the content 124 that the user 102 is focused on by analyzing the sensor data 120, the characteristics 128, and/or the content 122.

Further, the focus group system 104 may utilize the feedback 130 and sensor data 120 to determine the user’s mood or reception in association with the particular content output by the user system 106 that is the user’s focus.

For example, the focus group system 104 may process the image data, audio data and/or other physiological data of the sensor data 120 to supplement or assist with determining the user’s mood or reception in association with the content determined to be the user’s focus. For example, the focus group system 104 may utilize the image data of the sensor data 120 to detect facial expressions as the subject responds to stimulus presented on the subject device. In some implementations, the focus group system 104 may also perform speech to text conversion in substantially real time on audio data of the sensor data 120 captured from the user. In these implementations, the focus group system 104 may also utilize text analysis and/or machine learned models to assist in determining the user’s mood or reception in association with the particular content output by the user system 106 that is the user’s focus. For example, the focus group system 104 may perform sentiment analysis that may include detecting use of negative words and/or positive words and together with the image processing and biometric data processing generate more informed determinations of the user’s mood or reception. In some cases, the focus group system 104 may aggregate or perform analysis over multiple users. For instance, the focus group system 104 may detect similar words, (verbs, adjectives, etc.) used to in conjunction with discussion of similar content, questions, stimuli, and/or products by different users. In some examples, the focus group system 104 may utilize various techniques and processes to maintain synchronization or association between content output at a given time and the user’s focus and response thereto.

As mentioned above, in some implementations, the content that is the user’s focus and the magnitude of the user’s reaction in association with the particular content in focus may be reliably determined based on the sensor data 120 (e.g., image data associated with the eyes and facial features of the user, blood pressure, heart rate, pulse oximetry, respiratory rate, brain activity, body movement, etc.) but the direction of the user’s reaction as determined based on the sensor data 120 may be less reliable. At the same time, the feedback 130 may be a reliable indicator of the direction of the user’s reaction but a less reliable indicator as to the magnitude of that reaction. The focus group system 104 may utilize both the feedback 130 and sensor data 120 to determine both the direction and magnitude of the user’s reaction. In some implementations, the focus group system 104 may utilize the feedback 130 to determine the direction of the user’s reaction or mood and utilize the sensor data 120 to determine the magnitude of the user’s reaction. Alternatively or additionally, the focus group system 104 may utilize both the feedback 130 and sensor data 120 for determining both the direction of the user’s reaction and magnitude thereof. For example, the determination of the direction of the user’s reaction may be biased to be primarily based on the feedback 130 but the system may override the user’s feedback 130 where the analysis of the sensor data strongly favors the opposite direction. In the case of the magnitude of the user’s reaction, the focus group system 104 may bias the determination of the magnitude of the user’s reaction to be primarily based on the sensor data but refine the determination based on the direction of the user’s reaction provided in the feedback 130. For example, where a given set of facial features and/or other sensor data 120 may be present in both a mild positive reaction and a very negative reaction, a positive or negative direction indicated in the feedback 130 may assist in determining the magnitude of the user’s reaction by eliminating possible magnitudes in the opposite direction. Similarly, where the feedback indicates the user’s reaction was neutral, the focus group system 104 may eliminate very positive reactions and very negative reactions. Further, where the feedback 130 indicates the user’s reaction was neutral, the focus group system 104 may utilize the sensor data 120 to determine a direction and a magnitude by biasing the determination based on the sensor data 120 to mild reactions that match the sensor data 120. While the above discussion relates to procedural determinations of the direction and magnitude of a user’s reaction based on the sensor data 120 and the feedback 130, this is merely an example for discussion purposes. Alternatively or additionally, the focus group system 104 may make such determinations using machine learning algorithm(s). For example, a machine learned model may be trained to determine a user’s reaction based on training data including sensor data 120 and feedback 130 provided by users during training, along with data providing ground truth information for the users' reactions.

Other example details of a focus group system and variations thereof are described, for example, in U.S. Pat. Application No. 16/775,015 filed on Jan. 28, 2020 entitled “System For Providing A Virtual Focus Group Facility”, the entire contents of which are hereby incorporated by reference.

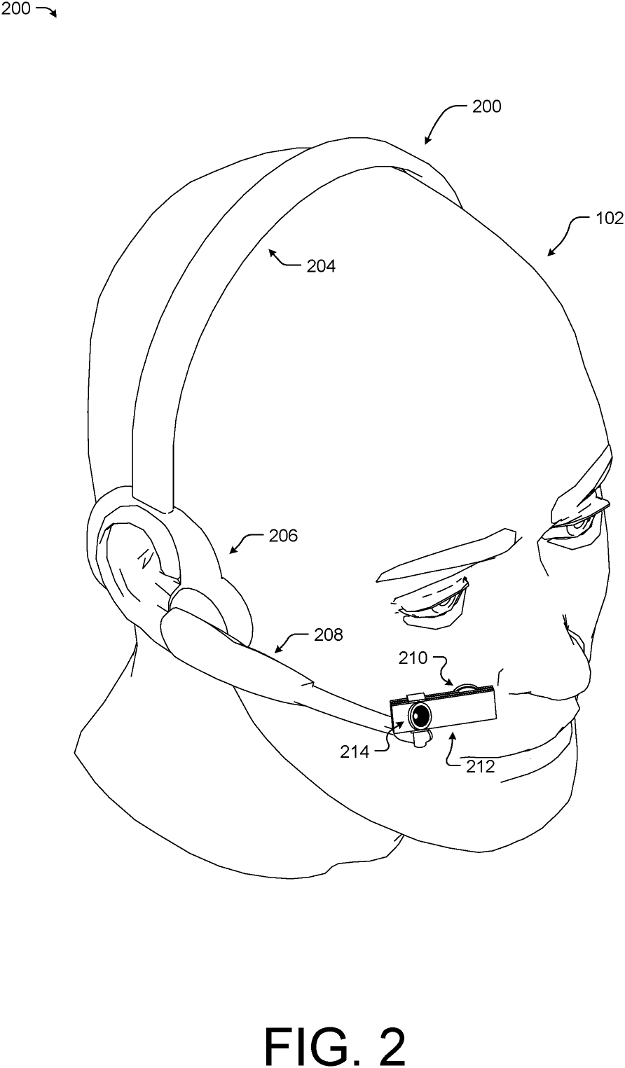

FIG. 2 illustrates an example eye tracking device 200 configured to capture sensor data usable for eye tracking according to some implementations. In some implementations, the eye tracking device 200 may correspond to the eye tracking device of the physiological monitoring system 114 of FIG. 1. In the current example, the eye tracking device 200 is being worn by a user 102 that may be consuming digital content via a display device and/or interacting with a physical object (such as in a focus group environment). In this example, the eye tracking device 200 includes a head-strap 204 that is secured to the head of the user 102 via an earpiece, generally indicated by 206. As illustrated, the earpiece 206 is configured to wrap around the ear of the user 102. In this manner, the ear canal is unobstructed and the user 102 may consume content 122 normally and engage in conversation.

A boom arm 208 extends outward from the earpiece 206. The boom arm 208 may extend past the face of the user 102. In some examples, the boom arm 208 may be extendable, while in other case the boom arm 208 may have a fixed position (e.g., length). In some examples, the boom arm 208 may be between five and eight inches in length or adjustable between five and eight inches in length.

In this example, a monocular inward-facing image capture device 210 may be positioned at the end of the boom arm 208. The inward-facing image capture device 210 may be physically coupled to the boom arm 208 via an adjustable mount 212. The adjustable mount 212 may allow the user 102 and/or another individual to adjust the position of the inward-facing image capture device 210 with respect to the face (e.g., eyes, cheeks, and forehead) of the user 102. In some cases, the boom arm 208 may adjust between four and eight inches from the base at the earpiece 206. In some cases, the adjustable mount 212 may be between half an inch and two inches in length, between half an inch and one inch in width, and less than half an inch in thickness. In another case, the adjustable mount 212 may be between half an inch and one inch in length. The adjustable mount 212 may maintain the inward-facing image capture device 210 at a distance of between two inches and five inches from the face or cheek of the user 102.

In some cases, the adjustable mount 212 may allow for adjusting a roll, pitch, and yaw of the inward-facing image capture device 210, while in other cases the adjustable mount 212 may allow for the adjustment of a swivel and tilt of the inward-facing image capture device 210. As discussed above, the inward-facing image capture device 210 may be adjusted to capture image data of the face of the user 102 including the eyes (e.g., pupil, iris, corneal reflections, etc.), the corrugator muscles, and the zygomaticus muscles.

In the current example, the eye tracking device 200 also includes an outward-facing image capture device 214. The outward-facing image capture device 214 may be utilized to assist with determining a field of view of the user 102. For example, if the user 102 is viewing a physical object, the outward-facing image capture device 214 may be able to capture image data of the object that is usable in conjunction with the image data captured by the inward-facing image capture device 210 to determine a portion of the object or location of the focus of the user 102. In the current example, the outward-facing image capture device 214 is mounted to the adjustable mount 212 with the inward-facing image capture device 210. However, it should be understood that the outward-facing image capture device 214 may have a separate mount in some implementations and/or be independently adjustable (e.g., position, roll, pitch, and yaw) from the inward-facing image capture device 210.

In the current example, a single image capture device 210 is shown. However, it should be understood, that the image capture device 210 may include multiple image capture devices, such as a pair of red-green-blue (RGB) image capture devices, an infrared image capture device, and the like. In other cases, the inward-facing image capture device 210 may be paired with and the adjustable mount 212 may support an emitter (not shown), such as an infrared emitter, projector, and the like, that may be used to emit a pattern onto the face of the user 102 that may be captured by the inward-facing image capture device 210 and used to determine a state of the corrugator muscles, and the zygomaticus muscles of the user 102. In some cases, the emitter and the inward-facing image capture device 210 may be usable to capture data associated with the face of the user 102 to determine an emotion or a user response to stimulus presented either physically or via a display device.

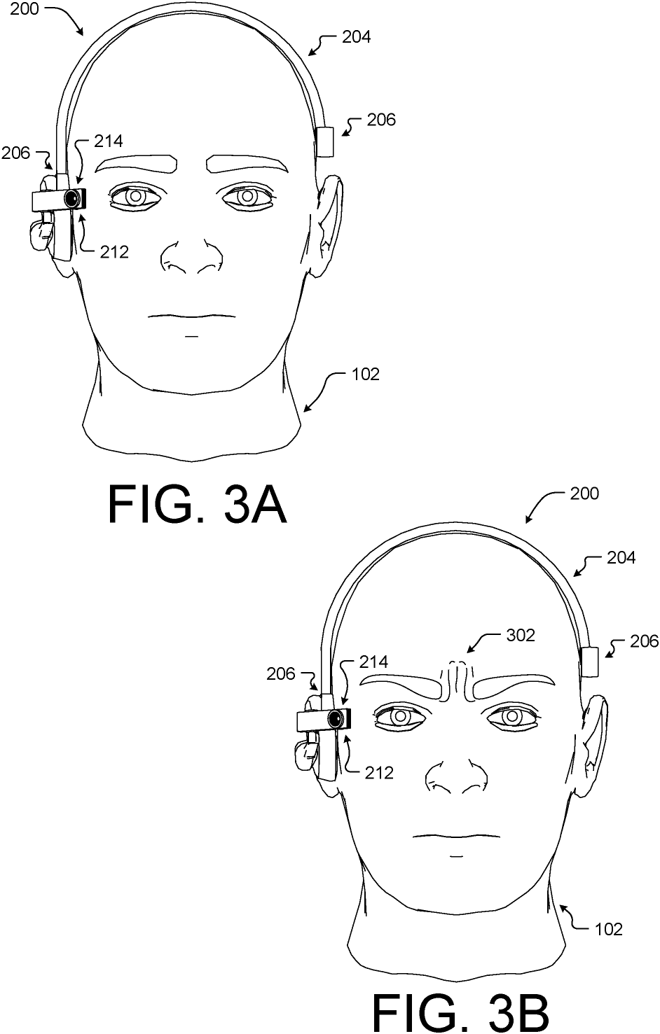

FIGS. 3A and 3B illustrate example front views of the eye tracking device 200 of FIG. 2 according to some implementations. In FIG. 3A, the user 102 may be calm or have little reaction to the stimulus being presented as the eye tracking device 200 captures image data usable to preform eye tracking. However, in FIG. 3B, the user 102 may be exposed to a stimulus that causes the user 102 to furrow the user’s brow (indicating anger, negative emotion, confusion, and/or other emotions) or otherwise contract the corrugator muscles, as indicated by 302. In this example, the inward-facing image capture device 210 may be positioned to capture image data associated with the furrowed brow 302 and the image data may be processed to assist with determining a focus of the user 102 as well as a mood or emotional response to the stimulus that was introduced.

The eye tracking device 200 also includes the outward-facing image capture device 214. The outward-facing image capture device 214 may be utilized to assist with determining a field of view of the user 102. For example, if the user 102 is viewing a physical object, the outward-facing image capture device 214 may be able to capture image data of the object that is usable in conjunction with the image data captured by the inward-facing image capture device to determine a portion of the object or location of the focus of the user 102. In the current example, the outward-facing image capture device 214 is mounted to the adjustable mount 212 with the inward-facing image capture device. However, it should be understood that the outward-facing image capture device 214 may have a separate mount in some implementations and/or be independently adjustable (e.g., position, roll, pitch, and yaw) from the inward-facing image capture device 210.

FIG. 1-3B illustrate various examples of the physiological monitoring system 114 and eye tracking device 200. It should be understood, that the examples of FIG. 1-3B are merely for illustration purposes and that components and features shown in one of the examples of FIG. 1-3B may be utilized in conjunction with components and features of the other examples.

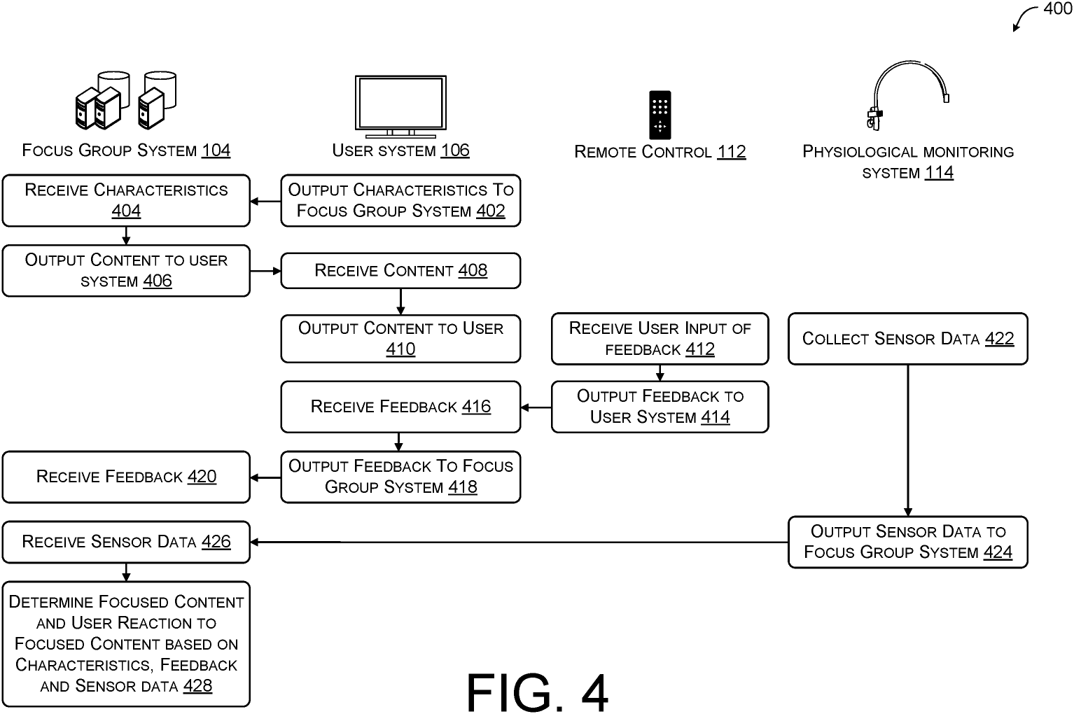

FIG. 4 illustrates an example flow diagram showing an illustrative process 400 for determine a focus of a user and the user’s reaction to the focus according to some implementations. In some implementations, a platform may include a focus group system 104, a user system 106, a remote control 112 and a physiological monitoring system 114.

At 402, the user system 106 may output characteristics of the user system 106 to the focus group system 104. In some examples, the characteristics may include characteristics of a display device of the user system 106 such as screen size, resolution, make, model, type, and the like. At 404, the focus group system 104 may receive and store the characteristics (e.g., for later use in determining content that is the focus of the user).

At 406, the focus group system 104 may output content to the user system 106. In some examples, the content may include visual content (e.g., image or video) as well as other content such as audio content for which the user’s reaction is to be determined. In addition, the content may include a prompt (or other indicator) requesting the user provide a rating or other form of feedback.

At 408, the user system 106 may receive content from the focus group system 104. Then, at 410, the user system 106 may output the content for consumption by the user 102 (e.g., as an audiovisual display via a display and speakers of the user system 106).

At 412, the remote control 112 may receive user input of feedback responsive to the content (e.g., in response to the prompt included in the content). For example, the user may input feedback as a rating on a scale of 1 to 5, with 1 being a strong negative reaction, a 2 being a mild negative reaction, a 3 being a neutral reaction, a 4 being a mild positive reaction and 5 being a strong positive reaction. In another example, the remote control 112 may include a dial with values from -50 to 50, -100 to 100 or 1 to 100 and the prompt may not include a scale, but ask the user to dial a value. At 414, the remote control 112 may output the feedback to the user system 106. At 416, the user system 106 may receive feedback from the remote control 112. At 418, the user system 106 may output the feedback to the focus group system 104. Then, at 420, the focus group system 104 may receive and store the feedback (e.g., for use in determining the user’s response to the content that is the focus of the user). As mentioned above, in some examples, the feedback may be provided to the focus group system 104 directly (e.g., via a input device of the focus group system 104), provided to the focus group system 104 by the remote control 112 without relay though systems 106 or 114, relayed via the physiological monitoring system 114, and so on.

At 422, which may occur concurrent or in sequence to 412, the physiological monitoring system 114 may collect sensor data. In some examples, the sensor data may include image data captured by inward-facing image capture devices of the physiological monitoring system 114 as well as image data captured by outward-facing image capture devices of the physiological monitoring system 114. The sensor data may also include sensor data captured by other sensors of the physiological monitoring system 114, (e.g., audio data (e.g., speech of the user), blood pressure data, heart rate data, pulse oximetry data, respiratory data, brain activity data, body movement data, etc.). At 424, the physiological monitoring system 114 may output the sensor data to the focus group system 104. Then, at 426, the focus group system 104 may receive and store the sensor data (e.g., for use in determining the content output by the user system that is the user’s focus and the user’s response to the content that is the user’s focus).

At 428, the focus group system 104 may determine the content output by the user system that is the user’s focus and the user’s response to the content that is the user’s focus based on the characteristics, the feedback and the sensor data. For example, the focus group system 104 may determine a portion of the content that the user is focused on by analyzing the sensor data in conjunction with the characteristics of the output device (e.g., display device) of the user system 106 and the content. Further, the focus group system 104 may utilize the feedback and sensor data to determine the user’s mood or reception in association with the particular content output by the user system 106 that is the user’s focus. As would be understood by one of skill in the art, the operations associated with, for example, outputting content to the user, receiving feedback and collecting sensor data may be performed repeatedly. Similarly, the operations associated with determining the content output by the user system that is the user’s focus and the user’s response to the content that is the user’s focus may be performed repeatedly as new feedback and the sensor data are received. In some examples, the focus group system 104 may utilize various techniques and processes to maintain synchronization or association between content output at a given time and the determination of the user’s focus and response thereto.

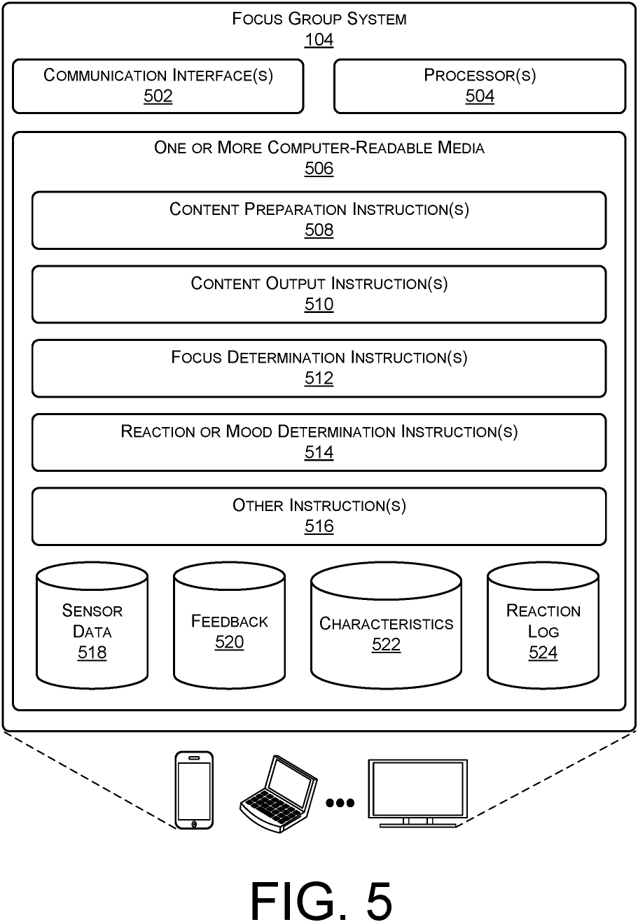

FIG. 5 illustrates an example focus group system 104 for providing a virtual focus group according to some implementations. In the illustrated example, the focus group system 104 includes one or more communication interfaces 502 configured to facilitate communication between one or more networks, one or more system (e.g., user system 106, tracking system 114, and/or remote control 112 of FIG. 1). The communication interfaces 502 may also facilitate communication between one or more wireless access points, a master device, and/or one or more other computing devices as part of an ad-hoc or home network system. The communication interfaces 502 may support both wired and wireless connection to various networks, such as cellular networks, radio, WiFi networks, short-range or near-field networks (e.g., Bluetooth®), infrared signals, local area networks, wide area networks, the Internet, and so forth.

The focus group system 104 includes one or more processors 504, such as at least one or more access components, control logic circuits, central processing units, or processors, as well as one or more computer-readable media 506 to perform the function of the focus group system 104. Additionally, each of the processors 504 may itself comprise one or more processors or processing cores.

Depending on the configuration, the computer-readable media 506 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 504.

Several modules, such as instructions, data stores, and so forth, may be stored within the computer-readable media 506 and configured to execute on the processors 504. For example, as illustrated, the computer-readable media 506 stores content preparation instruction(s) 508, content output instruction(s) 510, focus determination instruction(s) 512, reaction or mood determination instruction(s) 514, as well as other instructions 516, such as an operating system. The computer-readable media 506 may also be configured to store data, such as sensor data 518 collected or captured with respect to a user associated with a user system 106 and physiological monitoring system 114, feedback 520 provided by a user (e.g., the user associated with the user system 106 and the physiological monitoring system 114), characteristics 522 (e.g., receive of one or output devices of the user system 106), and/or a reaction log 524 that may store or log the outcome of the focus group system’s determinations of the content output by the user system that is the user’s focus and the user’s response to the content that is the user’s focus.

The content preparation instruction(s) 508 may be configured to prepare content to be output to the user by the user system 106. For example, the content preparation instruction(s) 508 may include instructions to cause processor(s) 504 of the focus group system 104 to add a prompt for feedback to visual content that is to be output to the user. Various other operations may also be performed to prepare the content for output to the user.

The content output instruction(s) 510 may be configured to output the content to the user system 106. In some examples, the content output instruction(s) 510 may be configured to output the content such that subsequently received feedback and sensor data captured in conjunction with the user’s consumption of the content may be associated with the content.

The focus determination instruction(s) 512 may be configured to analyze the sensor data 518 collected from the physiological monitoring system 114 along with the content and the characteristics 522 of the user system to determine the content output by the user system that is the user’s focus. As discussed above, the focus determination instruction(s) 512 may utilize various procedural processes, machine learned models, neural networks, or other data analytic techniques when determining the focused content. The focus determination instruction(s) 512 may further be configured to log the determined focus content in the reaction log 524 in association with the corresponding content (e.g., as output to the user system) and the corresponding user’s reaction to the determined focused content (e.g., as determined by the reaction or mood determination instructions(s) 514, discussed below).

The reaction or mood determination instructions(s) 514 may be configured to analyze the sensor data 518 and feedback 520 determine the user’s response to the content that is the user’s focus. As discussed above, the reaction or mood determination instructions(s) 514 may utilize various procedural processes, machine learned models, neural networks, or other data analytic techniques when determining the user’s response to the content that is the user’s focus. The reaction or mood determination instructions(s) 514 may further be configured to log the determined user’s response to the content that is the user’s focus in the reaction log 524 in association with the corresponding content (e.g., as output to the user system) and the corresponding determined focused content (e.g., as determined by the focus determination instructions(s) 512, as discussed above).

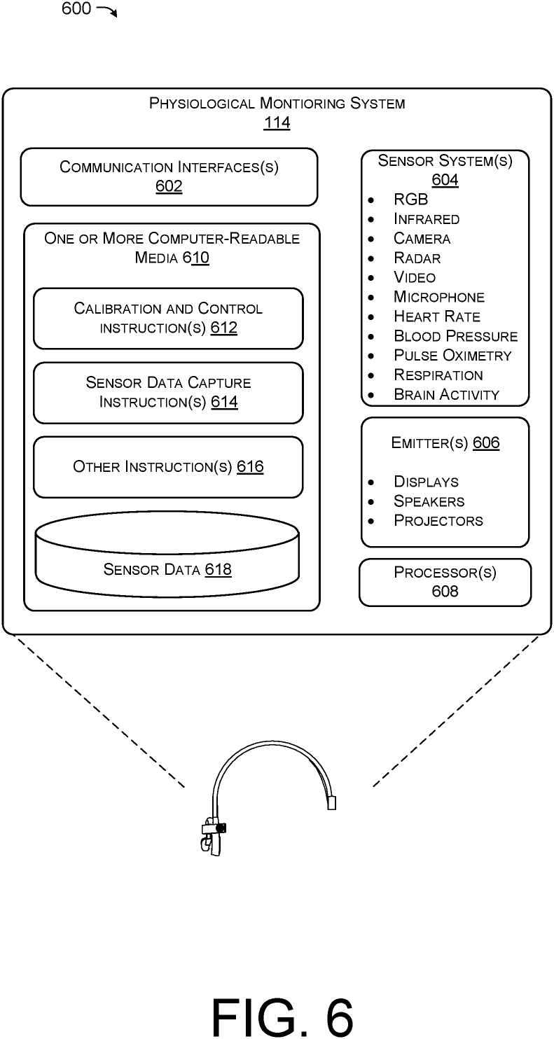

FIG. 6 illustrates an example physiological monitoring system 114 of FIG. 1 according to some implementations. As discussed above, while illustrated as a head mounted eye tracking device, the physiological monitoring system 114 is not so limited and other configurations are within the scope of this disclosure.

In the illustrated example, the physiological monitoring system 114 includes one or more communication interfaces 602 configured to facilitate communication between one or more networks, one or more system (e.g., a focus group system 104 of FIG. 1). The communication interfaces 602 may also facilitate communication between one or more wireless access points, a master device, and/or one or more other computing devices as part of an ad-hoc or home network system. The communication interfaces 602 may support both wired and wireless connection to various networks, such as cellular networks, radio, WiFi networks, short-range or near-field networks (e.g., Bluetooth®), infrared signals, local area networks, wide area networks, the Internet, and so forth.

In at least some examples, the sensor system(s) 604 may include image capture devices or cameras (e.g., RGB, infrared, monochrome, wide screen, high definition, intensity, depth, etc.), time-of-flight sensors, lidar sensors, radar sensors, sonar sensors, microphones, light sensors, cardiac monitoring sensors (e.g., heart rate sensors, blood pressure sensors, pulse oximetry sensors), pulmonary monitoring sensors (e.g., respiration sensors, air flow sensors, chest expansion sensors), brain activity monitoring sensors, etc. In some examples, the sensor system(s) 604 may include multiple instances of each type of sensors. For instance, multiple inward-facing cameras may be positioned about the physiological monitoring system 114 to capture image data associated with a face of the user.

The physiological monitoring system 114 may also include one or more emitter(s) 606 for emitting light and/or sound. The one or more emitter(s) 606, in this example, include interior audio and visual emitters to communicate with the user of the physiological monitoring system 114. By way of example and not limitation, emitters may include speakers, lights, signs, display screens, touch screens, haptic emitters (e.g., vibration and/or force feedback), and the like. The one or more emitter(s) 606 in this example also includes exterior emitters. By way of example and not limitation, the exterior emitters may include light or visual emitters, such as used in conjunction with the sensors 604 to map or define a surface of an object within an environment of the user as well as one or more audio emitters (e.g., speakers, speaker arrays, horns, etc.) to audibly communicate with, for instance, a focus group.

The physiological monitoring system 114 includes one or more processors 608, such as at least one or more access components, control logic circuits, central processing units, or processors, as well as one or more computer-readable media 610 to perform the function of the physiological monitoring system 114. Additionally, each of the processors 608 may itself comprise one or more processors or processing cores.

Depending on the configuration, the computer-readable media 610 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 608.

Several modules such as instructions, data stores, and so forth may be stored within the computer-readable media 610 and configured to execute on the processors 608. For example, as illustrated, the computer-readable media 610 stores calibration and control instruction(s) 612 and sensor data capture instructions 614, as well as other instructions 616, such as an operating system. The computer-readable media 610 may also be configured to store data, such as sensor data 618 collected or captured with respect to the sensor systems 604.

The calibration and control instructions 612 may be configured to assist the user with correctly aligning and calibrating the various components of the physiological monitoring system 114, such as the inward and outward-facing image capture devices to perform focus detection and eye tracking and/or other sensors. For example, the user may activate the physiological monitoring system 114 once placed upon the head of the user. The calibration and control instructions 612 may cause image data being captured by the various inward and outward-facing image capture device to be displayed on a remote display device visible to the user. The calibration and control instructions 612 may also cause alignment instructions associated with each image capture device to be presented on the remote display. For example, the calibration and control instructions 612 may be configured to analyze the image data from each image capture device to determine if it is correctly aligned (e.g., aligned within a threshold or is capturing desired features). The calibration and control instructions 612 may then cause alignment instructions to be presented on the remote display, such as “adjust the left outward-facing image capture device to the left” and so forth until each image capture device is aligned. Also, in addition to the providing visual instructions to a remote display, the calibration and control instructions 612 may utilize audio instructions output by one or more speakers. Similar operations may be performed to calibrate other sensors of the physiological monitoring system 114.

The calibration and control instruction(s) 612 may further be configured to interface with the focus group system 104 to perform various focus group operations and to return sensor data thereto. For example, the calibration and control instruction(s) 612 may cause the communication interfaces 602 to transmit, send, or stream sensor data 618 to the focus group system 104 for processing.

The data capture instruction(s) 614 may be configured to cause the sensors to capture sensor data. For example, the data capture instruction(s) 614 may be configured to cause the image capture devices to capture image data associated with the face of the user and/or the environment surrounding the user. The data capture instruction(s) 614 may be configured to time stamp the sensor data such that the data captured by sensors may be compared using the corresponding time stamps.

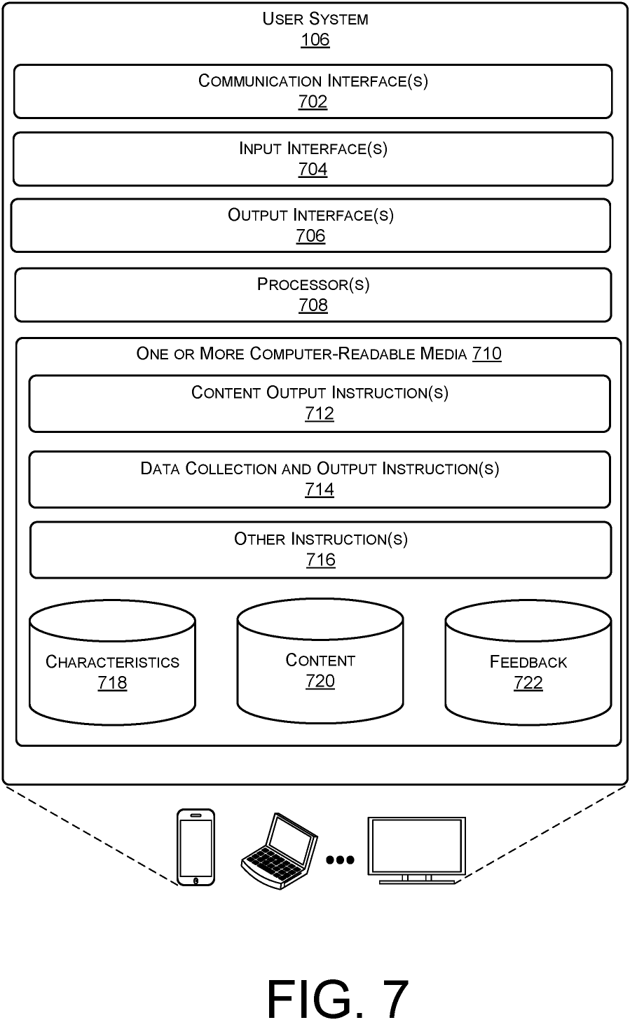

FIG. 7 illustrates an example user system 106 associated with the focus group platform of FIG. 1 according to some implementations. As illustrated with respect to FIG. 1, the user system 106 may include one or more devices (e.g., a set top box and a television).

In the illustrated example, the system 106 includes one or more communication interfaces 702 configured to facilitate communication between one or more networks, one or more systems (e.g., focus group system 104 and remote control 112 of FIG. 1). The communication interfaces 702 may also facilitate communication between one or more wireless access points, a master device, and/or one or more other computing devices as part of an ad-hoc or home network system. The communication interfaces 702 may support both wired and wireless connection to various networks, such as cellular networks, radio, WiFi networks, short-range or near-field networks (e.g., Bluetooth®), infrared signals, local area networks, wide area networks, the Internet, and so forth.

The user system 106 also includes input interfaces 704 and the output interface 706 may be included to display or provide information to and to receive inputs from a user, for example, via the remote control 112. The interfaces 704 and 706 may include various systems for interacting with the user system 106, such as mechanical input devices (e.g., keyboards, mice, buttons, etc.), displays, input sensors (e.g., motion, age, gender, fingerprint, facial recognition, or gesture sensors), and/or microphones for capturing natural language input such as speech. In some examples, the input interface 704 and the output interface 706 may be combined in one or more touch screen capable displays.

The user system 106 includes one or more processors 708, such as at least one or more access components, control logic circuits, central processing units, or processors, as well as one or more computer-readable media 710 to perform the function associated with the virtual focus group. Additionally, each of the processors 708 may itself comprise one or more processors or processing cores.

Depending on the configuration, the computer-readable media 710 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 708.

Several modules such as instruction, data stores, and so forth may be stored within the computer-readable media 710 and configured to execute on the processors 708. For example, as illustrated, the computer-readable media 710 stores content output instruction(s) 712, data collection and output instructions(s) 714, as well as other instructions 716, such as an operating system. The computer-readable media 710 may also be configured to store data, such as characteristics 718 of an output device of the user system 106, content 720 provided by the focus group system 104 to be output to the user, and feedback 722 from the user collected with respect to the content.

The content output instructions 712 may be configured to cause the audio and video data received from the focus group system 104 to be displayed via the output interfaces (e.g., via a display device).

The data collection and output instructions(s) 714 may be configured to the user system 106 to report the characteristics 718 of, for example, a display device of the user system 106 to the focus group system 104. The data collection and output instruction(s) 714 may further be configured to collect feedback 722 from the user, for example via a remote control 112 or other input interface 704 in association with the content 720 being output for consumption by the user. The data collection and output instruction(s) 714 may further be configured to cause the user system 106 to output the feedback 722 to the focus group system 104.

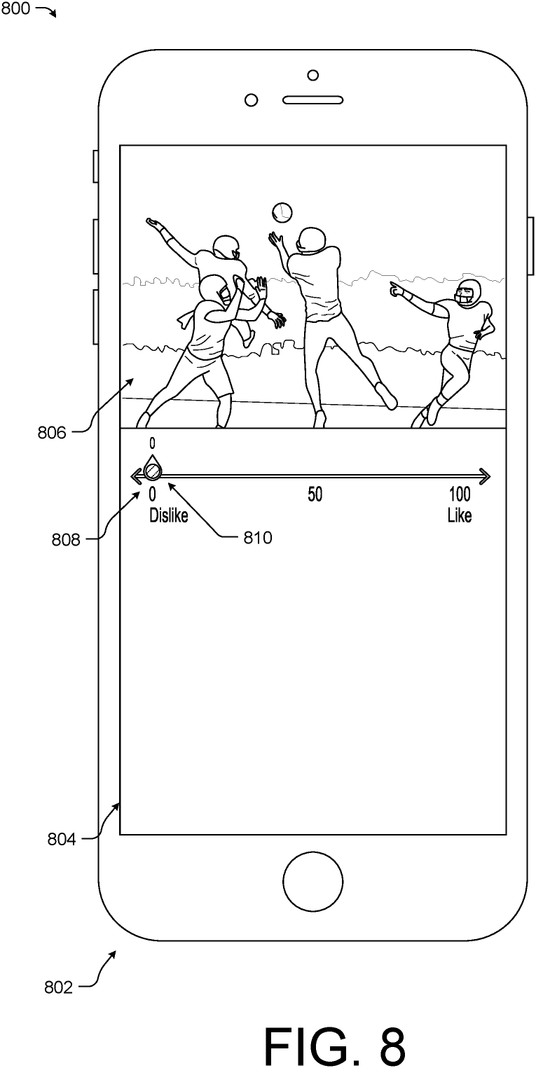

FIG. 8 illustrates an example user system 800 which may be configured to present content to a user and to receive user feedback according to some implementations. As illustrated, the user system may include a user device 802, illustrated as a computing device with a touch screen display 804 that may output the content 806 for consumption by the user and receive feedback via a feedback interface 808 also displayed on the touch screen display 804. As shown, the user system 800 may be a cell phone of a user. However, implementations are not so limited and other computing devices may be used.

As illustrated, the content 806 may include visual content (e.g., image or video) as well as other content such as audio content for which the user’s reaction is to be determined. The feedback interface 808 may include a slider (or other indicator) requesting the user provide a rating or other form of feedback. As illustrated, the feedback interface 808 includes a slider for presenting user feedback ranging from the currently selected value 810 of “0” indicating dislike to a value of “100” indicating like.

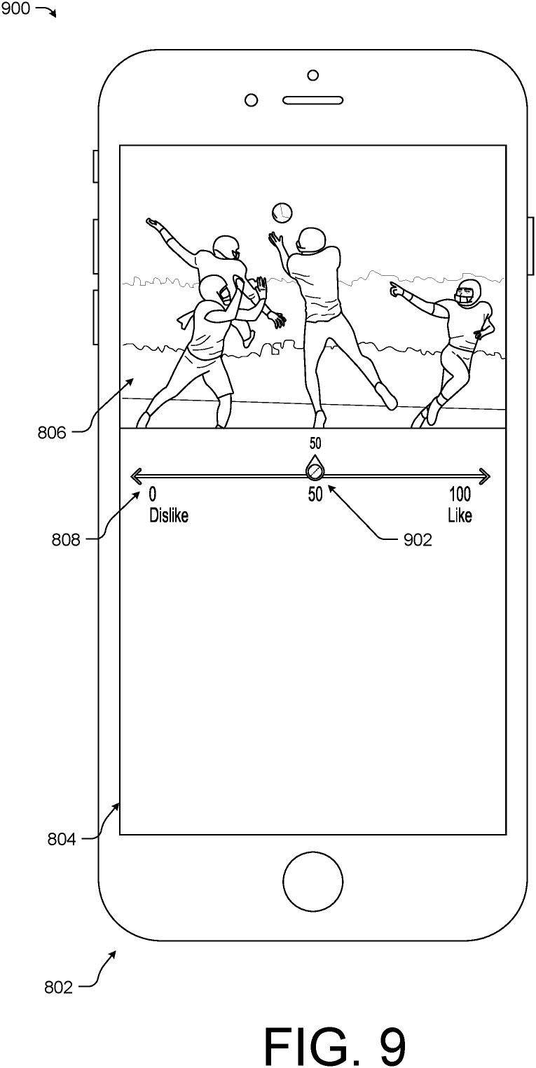

FIG. 9 illustrates the example user system 900 which may be configured to present content to a user and to receive user feedback according to some implementations. More particularly, user system 900 may illustrate user system 800 following an input by the user to the feedback interface 808 displayed by the touch screen display 804 to change the user feedback from a “0” to a currently selected value 902 of “50” indicating a neutral response.

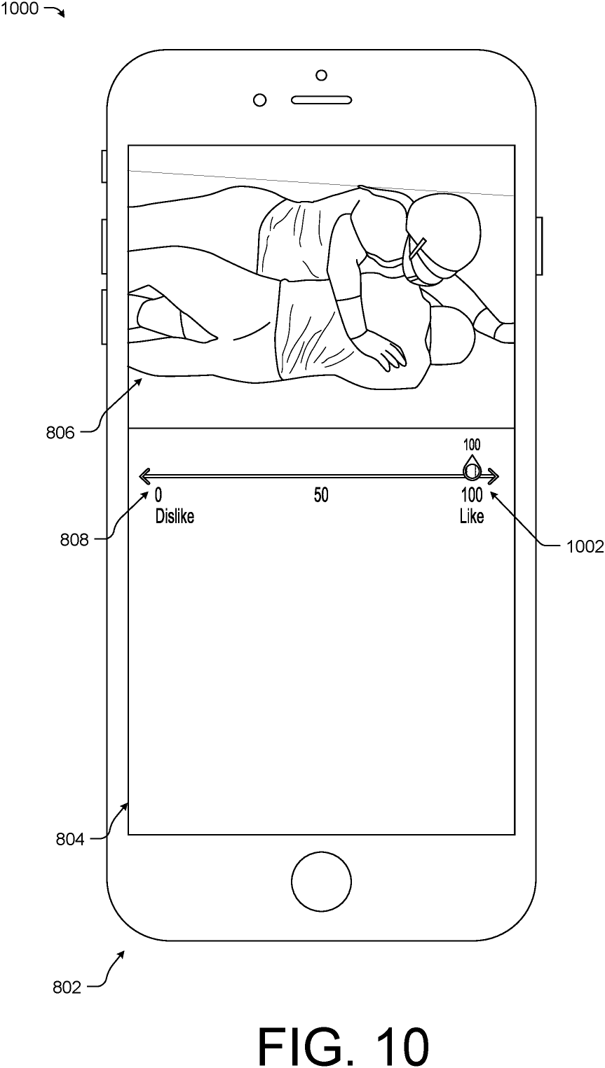

FIG. 10 illustrates the example user system 1000 which may be configured to present content to a user and to receive user feedback according to some implementations. More particularly, user system 1000 may illustrate user system 900 following another input by the user to the feedback interface 808 displayed by the touch screen display 804 to change the user feedback from a “50” to a currently selected value 1002 of “100” indicating a like or positive response.

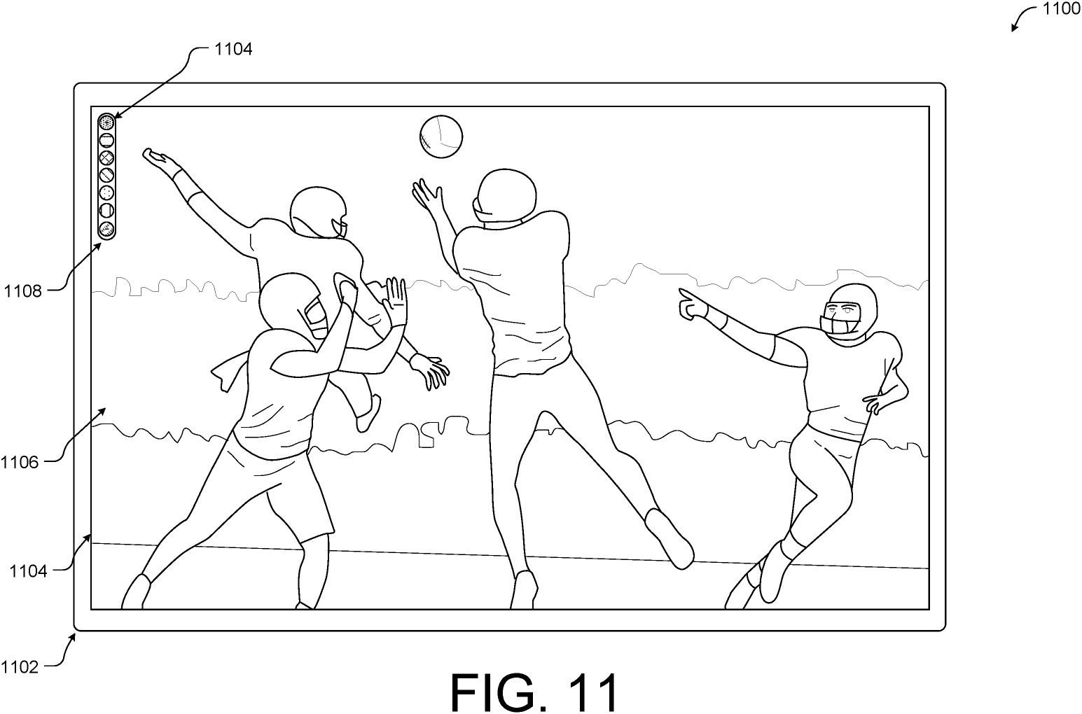

FIG. 11 illustrates an example user system 1100 which may be configured to present content to a user and to receive user feedback according to some implementations. As illustrated, the user system 1100 may include a user device 1102, illustrated as a computing device with a touch screen display 1104 that may output the content 1106 for consumption by the user and receive feedback via a feedback interface 1108 also displayed on the touch screen display 1104. As shown, the user system 1100 may be a tablet device of a user. However, implementations are not so limited and other computing devices may be used.

As illustrated, the content 1106 may include visual content (e.g., image or video) as well as other content such as audio content for which the user’s reaction is to be determined. The feedback interface 1108 may include a graphic scale rating (or other indicator) requesting the user provide a rating or other form of feedback. As illustrated, the feedback interface 1108 includes a graphic scale for presenting user feedback ranging from the very positive ratings to very negative ratings, depending on how far the circle selected by the user is from the center of the scale.

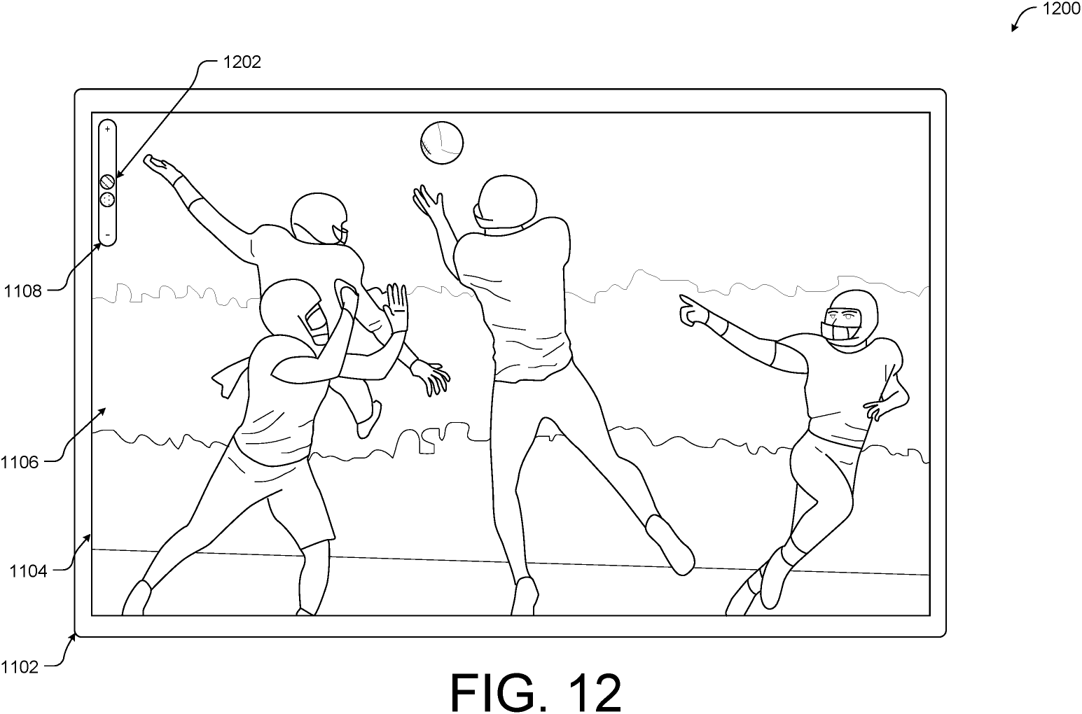

FIG. 12 illustrates the example user system 1200 which may be configured to present content to a user and to receive user feedback according to some implementations. More particularly, user system 1200 may illustrate user system 1100 following an input by the user to the feedback interface 1108 displayed by the touch screen display 1104 to indicate a user feedback 1202 of that is one circle into the negative feedback portion of the graphic scale indicating a mildly negative response to the content 1106.

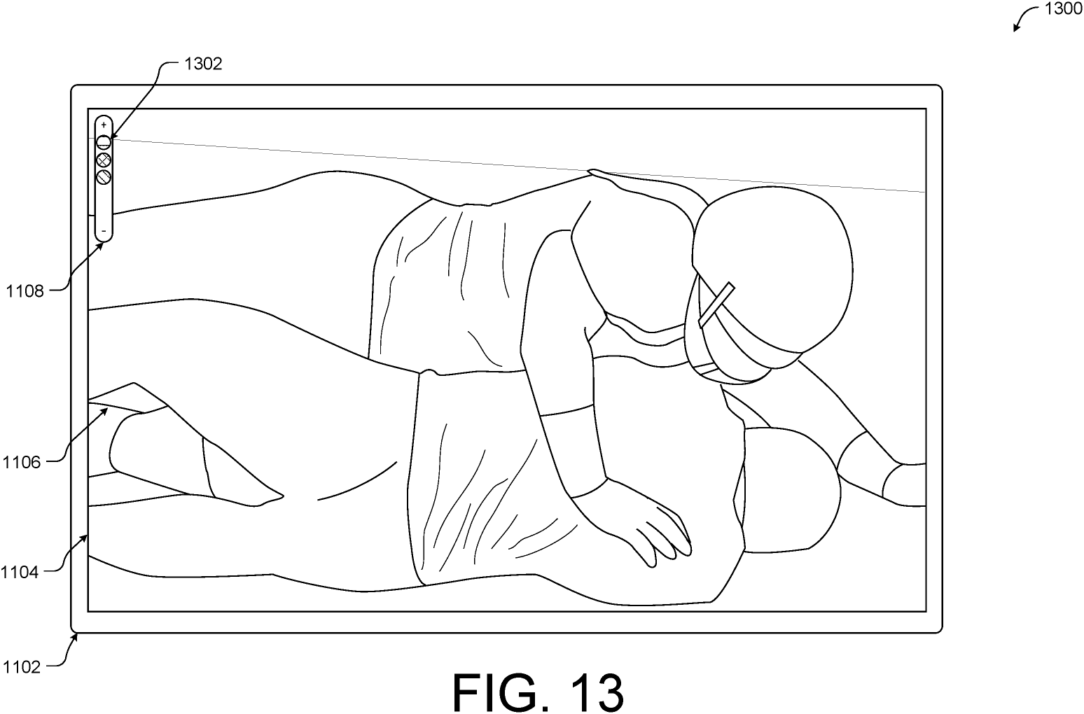

FIG. 13 illustrates the example user system 1300 which may be configured to present content to a user and to receive user feedback according to some implementations. More particularly, user system 1300 may illustrate user system 1200 following another input by the user to the feedback interface 1108 displayed by the touch screen display 1104 to indicate a user feedback 1302 that is two circles into the positive feedback portion of the graphic scale indicating a positive response to the content 1106.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A system comprising:
one or more processors; and
computer-readable media storing instructions executable by the one or more processors, wherein the instructions cause the system to perform operations comprising:
receiving sensor data from a physiological monitoring device including physiological data of a user captured while the user is consuming content;
receiving feedback of the user based on an input of the user representing a subjective assessment by the user of a reaction of the user when the and sensor data of the user was captured while the user was consuming the content; and
determining, based at least in part on the sensor data and the feedback, a direction and magnitude of the reaction of the user to the content.

2. The system as recited in claim 1, wherein the direction of the reaction of the user to the content is indicative of whether the reaction of the user is positive or negative.

3. The system as recited in claim 1, wherein the determining, based at least in part on the sensor data and the feedback, the direction and the magnitude of the reaction of the user to the content includes one of:
a first bias that causes the determining of the direction of the reaction of the user to the content to emphasize the feedback over the sensor data and a second bias that causes the determining of the magnitude of the reaction of the user to the content to emphasize the sensor data over the feedback; or
the determining of the direction of the reaction of the user to the content is performed without consideration of the sensor data and the determining of the magnitude of the reaction of the user to the content is performed without consideration of the feedback.

4. The system as recited in claim 1, wherein the sensor data includes one or more images including one or more facial images of a face of the user and one or more outward images associated with a field of view of the user when the one or more images were captured; and
the operations further comprising:
determining, based at least on the sensor data, a focused portion of the content that was a focus of the user when the one or more images were captured; and
wherein the determining, based at least in part on the sensor data and the feedback, the direction and magnitude of the reaction of the user to the content is associated with the focused portion of the content.

5. The system as recited in claim 4, the operations further comprising:
receiving characteristics of an output device of a user system from which user is consuming the content; and
wherein the determining of the focused portion of the content that was the focus of the user when the one or more images were captured is further based on the characteristics of the output device and the one or more outward images.

6. The system as recited in claim 4, wherein the one or more facial images of the face of the user include image data of an eyebrow region of the face of the user, a cheek region of the face of the user, and an eye region of the face of the user.

7. The system as recited in claim 1, the operations further comprising:
outputting the content to a user system; and
receiving the feedback from the user system.

8. The system as recited in claim 7, wherein the user system includes a set top box and a remote control.

9. A method comprising:
receiving sensor data from a physiological monitoring device including physiological data of a user captured while the user is consuming content;
receiving feedback of the user based on an input of the user representing a subjective assessment by the user of a reaction of the user when the sensor data of the user was captured while the user was consuming the content; and
determining, based at least in part on the sensor data and the feedback, a direction and magnitude of the reaction of the user to the content.

10. The method as recited in claim 9, wherein the direction of the reaction of the user to the content is indicative of whether the reaction of the user is positive or negative.

11. The method as recited in claim 9, wherein the determining, based at least in part on the sensor data and the feedback, the direction and the magnitude of the reaction of the user to the content includes one of:
a first bias that causes the determining of the direction of the reaction of the user to the content to emphasize the feedback over the sensor data and a second bias that causes the determining of the magnitude of the reaction of the user to the content to emphasize the sensor data over the feedback; or
the determining of the direction of the reaction of the user to the content is performed without consideration of the sensor data and the determining of the magnitude of the reaction of the user to the content is performed without consideration of the feedback.

12. The method as recited in claim 9, wherein the sensor data includes one or more images including one or more facial images of a face of the user and one or more outward images associated with a field of view of the user when the one or more images were captured; and
the method further comprising:
determining, based at least on the sensor data, a focused portion of the content that was a focus of the user when the one or more images were captured; and
wherein the determining, based at least in part on the sensor data and the feedback, the direction and magnitude of the reaction of the user to the content is associated with the focused portion of the content.

13. The method as recited in claim 12, further comprising:
receiving characteristics of an output device of a user system from which user is consuming the content; and
wherein the determining of the focused portion of the content that was the focus of the user when the one or more images were captured is further based on the characteristics of the output device and the one or more outward images.

14. The method as recited in claim 9, further comprising:
outputting the content to a set top box of a user system; and
receiving the feedback from the user system, the feedback based at least in part on input by the user to a remote control associated with the set top box.

15. One or more non-transitory computer-readable media storing instructions executable by one or more processors, wherein the instructions cause the one or more processors to perform operations comprising:
receiving sensor data from a physiological monitoring device including physiological data of a user captured while the user is consuming content;
receiving feedback of the user based on an input of the user representing a subjective assessment by the user of a reaction of the user when the sensor data of the user was captured while the user was consuming the content; and
determining, based at least in part on the sensor data and the feedback, a direction and magnitude of the reaction of the user to the content.

16. The one or more non-transitory computer-readable media of claim 15, wherein the direction of the reaction of the user to the content is indicative of whether the reaction of the user is positive or negative.

17. The one or more non-transitory computer-readable media of claim 15, wherein the determining, based at least in part on the sensor data and the feedback, the direction and the magnitude of the reaction of the user to the content includes one of:
a first bias that causes the determining of the direction of the reaction of the user to the content to emphasize the feedback over the sensor data and a second bias that causes the determining of the magnitude of the reaction of the user to the content to emphasize the sensor data over the feedback; or
the determining of the direction of the reaction of the user to the content is performed without consideration of the sensor data and the determining of the magnitude of the reaction of the user to the content is performed without consideration of the feedback.

18. The one or more computer-readable media of claim 15, wherein the sensor data includes one or more images including one or more facial images of a face of the user and one or more outward images associated with a field of view of the user when the one or more images were captured; and
the operations further comprising:
determining, based at least on the sensor data, a focused portion of the content that was a focus of the user when the one or more images were captured; and
wherein the determining, based at least in part on the sensor data and the feedback, the direction and magnitude of the reaction of the user to the content is associated with the focused portion of the content.

19. The one or more non-transitory computer-readable media of claim 18, the operations further comprising:
receiving characteristics of an output device of a user system from which user is consuming the content; and
wherein the determining of the focused portion of the content that was the focus of the user when the one or more images were captured is further based on the characteristics of the output device and the one or more outward images.

20. The one or more non-transitory computer-readable media of claim 15, the operations further comprising:
outputting the content to a set top box of a user system; and
receiving the feedback from the user system, the feedback based at least in part on input by the user to a remote control associated with the set top box.
